(19) United States
(12) Patent Application Publication
(10) Pub. No.: US 2018/0089621 A1
(43) Pub. Date: Mar. 29, 2018

(54) METHOD AND APPARATUS FOR COORDINATED FOOD DELIVERY

(71) Applicant: FORD GLOBAL TECHNOLOGIES, LLC, Dearborn, MI (US)

(72) Inventors: Oswaldo PEREZ BARRARA, Texcoco (MX); Alvaro JIMENEZ HERNANDEZ, Mexico City (MX); Maria Fernanda PULIDO PLAUCHUD, Toluca (MX); Pablo H. VALENCIA CHAPARRO, Mexico City (MX)

(21) Appl. No.: 15/280,406

(22) Filed: Sep. 29, 2016

(51) Int. Cl. G06Q 10/08

(52) U.S. Cl. CPC G06Q 10/0833; G06Q 50/12

(57) ABSTRACT

A system includes a processor configured to receive a request for a delivery order to a current saved-route destination. The processor is also configured to present food delivery options corresponding to the destination. The processor is further configured to receive delivery option selection, facilitate a food order, and instruct delivery initiation of the food order when the vehicle is within a first determined travel time from the destination, such that a delivery driver and the vehicle are estimated to arrive within a predetermined time of each other.

### TECHNICAL FIELD

The illustrative embodiments generally relate to a method and apparatus for coordinated food delivery.

### BACKGROUND

With the busy lifestyle and working habits of many people, people are always interested in food delivery services. Typically, a customer will place an order for food, and, unless the customer is also picking up the food, there will often be a thirty to forty five minute wait associated with delivery of the order.

While people are certainly willing to wait for their food to be prepared and delivered, a parent picking kids up from school, after the parent leaves their job, may arrive home with a hungry car-load of children who do not want to wait for the parent to prepare a meal. Further, the parent, having just completed a day of work, may not want to spend time and effort cooking.

The parent certainly has the option of having food delivered, in the preceding scenario, but again the family must wait while the food is prepared and delivered. The parent can attempt to accommodate this by calling in an order ahead of time, but traffic delays, weather and the like create some uncertainty about arrival times at home. If the parent waits too long to order (for example, when near the house), then the parent and family will still experience most of the wait while at home, waiting for the food to be delivered.

### SUMMARY

In a first illustrative embodiment, a system includes a processor configured to receive a request for a delivery order to a current saved route destination. The processor is also configured to present food delivery options corresponding to the destination. The processor is further configured to receive a delivery option selection, facilitate a food order, and instruct delivery initiation of the food order when the vehicle is within a first determined travel time from the destination, such that a delivery driver and the vehicle are estimated to arrive within a predetermined time of each other.

In a second illustrative embodiment, a system includes a processor configured to receive a driver-departure notification when a delivery driver leaves to deliver an order. The processor is also configured to receive driver-tracking information tracking the progress of the delivery driver and display driver-arrival information, based on the driver-tracking information, on a customer vehicle-related display, indicating delivery driver estimated arrival time.

In a third illustrative embodiment, a system includes a processor configured to receive indicia of a first-customer delay in a first destination arrival time. The processor is also configured to determine if a delivery driver should deliver a second-customer order first, based on the first-customer delay. The processor is further configured to confirm availability with a second customer to receive the second-customer order earlier than expected and, responsive to confirmation, instruct the delivery driver to deliver the second-customer order first.

### BRIEF DESCRIPTION OF THE DRAWINGS

FIG. 1 shows an illustrative vehicle computing system;

FIG. 2 illustrates an illustrative process for facilitating a food order;

FIG. 3 illustrates an illustrative process for customer and driver coordination;

FIG. 4 illustrates an illustrative process for order handling; and

FIG. 5 illustrates an illustrative process for delay accommodation.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

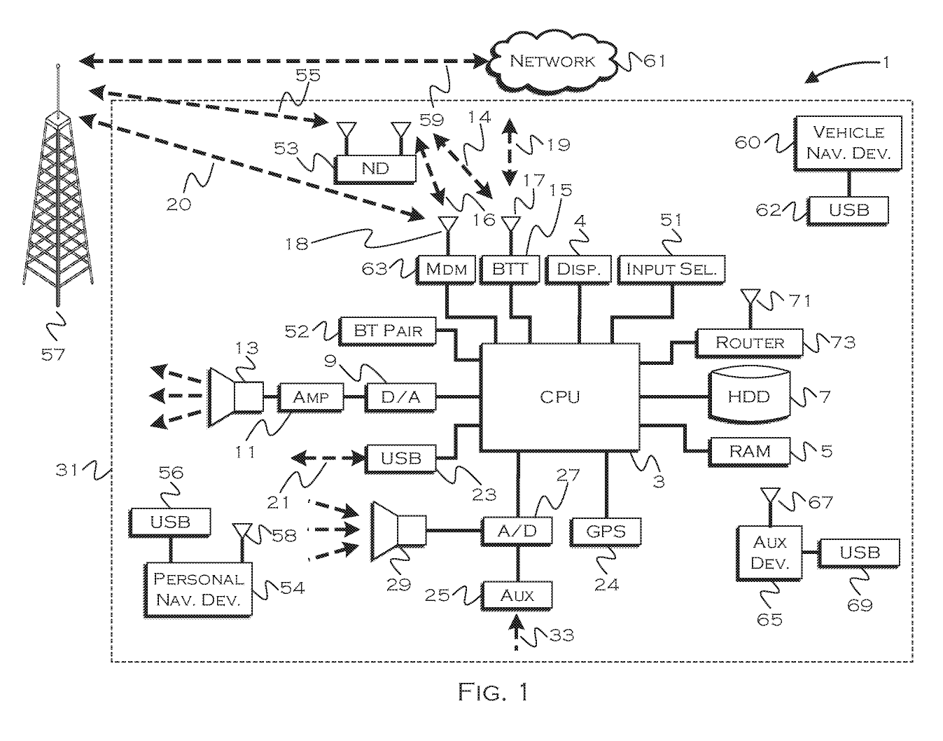

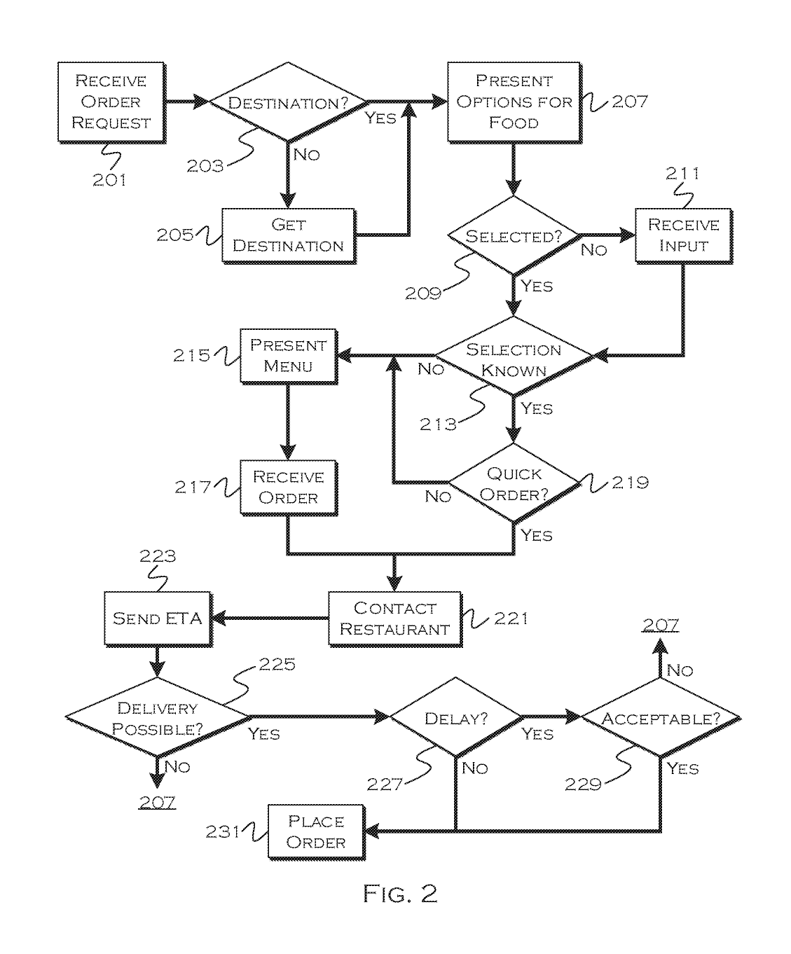

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

One of the common reasons why a person will abstain from placing a delivery order upon arriving home from work, for example, is that the person is hungry when they arrive. Placing a food order then involves finding a phone number or website, selecting items for order, placing the order and waiting for the delivery.

In order to accommodate this delay, the person may stop along the way home to pick up food or may place an order via the phone while driving home. In the former case, the person experiences a different form of delay as he or she must wait to order the food and wait while it is prepared. Further, eating while driving can be distracting, so the person may wait until arriving at home to eat, at which time the food may have become cold.

In the latter case, the person faces a minor dilemma with regards to timing. If the person orders too soon, and the delivery driver arrives at the house before the person does, then the delivery driver must wait for the person to arrive. This may result in an annoyed driver at best, and cold food and/or a driver who simply leaves without delivering the order, at worst. While navigation systems can provide some indication as to when a person will arrive at a destination, unexpected delays can pop up, and these estimates do not always accommodate all possible delays.

The illustrative embodiments provide a vehicle-supported food ordering system which allows for automatic coordination between a customer and a delivery driver. The illustrative systems and methods facilitate minimal distraction to the customer while driving and minimize the likelihood of poor timing between the customer and the driver. Further, by providing an ability to update both parties' locations in some examples, the illustrative embodiments help ensure that both parties know when the other party will arrive, so that all involved at least know about any potential delays.

Also, through integration with a navigation system in the customer's vehicle, some of the illustrative embodiments can automatically take the guesswork out of arrival times with respect to ordering and help ensure properly timed delivery of an order placed at any time.

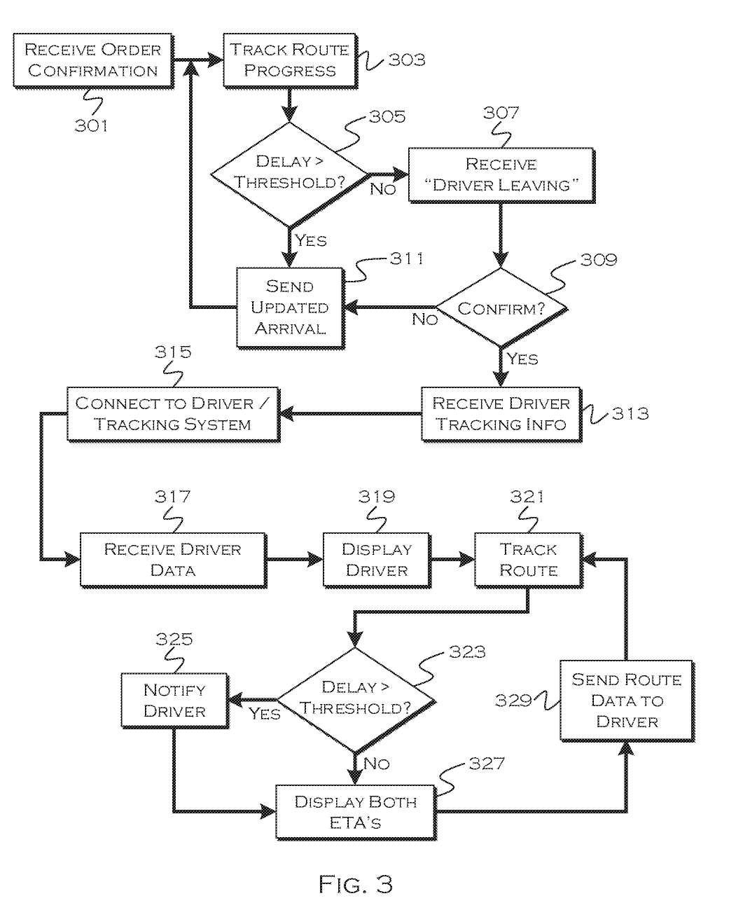

FIG. 2 shows an illustrative process for facilitating a food order. In this illustrative example, a customer is driving to a destination where the customer would like to have food delivered. Using the vehicle computing system, the customer (or another passenger, all occupants being collectively referred to as “the customer”) can input a request to order food 201.

In the illustrative embodiments, the restaurant will deliver the food to the customer's current destination or other indicated address. Accordingly, in this example, the process determines if a destination currently exists 203. If no destination exists, the process will obtain the destination from the customer 205, or, in other examples, the process will attempt to predict a destination based on context and past observed behavior.

Once the process has resolved a destination (which is the delivery address), the process presents a list of food options 207 on an in-vehicle display or wirelessly linked customer device, or other vehicle-related display. In some examples, the process may select options with a known delivery area that accommodates the destination. For example, a database of delivery areas for restaurants, or stored, observed past experience, may be a source for this information. Additionally or alternatively, the process may select restaurants and/or delivery-designated restaurants within a certain predetermined distance of the known destination.

The customer can select an option from the displayed list. If the customer selects a displayed option 209, the process continues, otherwise the customer has the option to input a different name 211, which the process can then attempt to find as the selected name, in order to present menu options.

If the process already knows and has menu or ordering data stored for the requested restaurant 213, the process can continue to check for a “quick order” procedure described below. If the process does not have menu or contact information for the selected restaurant, the process can submit a digital request for a menu (from the restaurant or a database of menus). In either instance (whether or not the process knows the menu), the process may present the menu 215 (once obtained, in the latter case) for selection of items for an order. In other examples, the process may simply place a call to the restaurant for facilitating the order, and serve as a delivery management process without handling the actual ordering.

In the case where the process already has a menu, there may also be a “quick order” option corresponding to a previously placed order. If the customer elects the “quick order” option 219, the process can use the saved, previous selection as the order. Otherwise, the menu presentation will occur, and the customer can select options for ordering from the digital menu if this feature is utilized (as opposed to simply calling the restaurant).

If communication with the restaurant has not already been established through a phone call for placing the order, the process will connect to the restaurant through a network or a processor-assisted phone call 221. The process will send an estimated time of arrival (ETA) to the restaurant 223, and receive a response as to whether or not the requested order can be delivered to the route-destination within a predetermined time period corresponding to the ETA. So, for example, if a customer will arrive home at 5:45 PM, in 45 minutes, the restaurant can determine if the food can be prepared and delivered no later than 6:00 PM. The customer can specify delivery-tolerances for later arriving orders (e.g., “6:30 PM is ok”), and the restaurant can determine a willingness to send out an order that might arrive early, because logistically it might make more sense to simply process the order and send it immediately, given high order demand, even if the driver may arrive at 5:40 PM and have to wait a few minutes for the customer.

It is also possible for the process to estimate preparation time, either the restaurant may have a “standard” time associated with certain food items or all orders, or each item can have a preparation time associated therewith and the process can aggregate these times to accommodate the estimated processing time. Whether the process or restaurant does the preparation estimation may depend on how much information is available to the process. In either event, the restaurant may need to input the availability of delivery options to the process, or update this information in a process-accessible database. That is, even if the food in the above example will only take 30 minutes to process and 10 minutes to delivery, this is no good for the customer if there are so many pending delivery orders that a delivery driver will not be available to deliver the food until 7:30 PM.

If delivery within an acceptable time period is not possible from the selected restaurant for the selected order 225, the process can return to step 207 and present a new list of food options, exempting the unavailable restaurant. While it is also possible to determine if a restaurant is “overloaded” with orders prior to placing an order (through a quick digital check with the restaurant or an updated online database showing availability), the restaurant may still want to confirm this information because it may be the case that the customer lives right next to an already planned delivery, and thus the restaurant could complete the order even in the face of high-demand.

If the restaurant indicates that delivery is possible, but that the delivery will be delayed by some time period 227, the customer can confirm whether or not the delay is acceptable 229. If the customer accepts the delay, the process can confirm the order 231.

FIG. 3 shows an illustrative process for customer and driver coordination. In this illustrative example, the process will track both the customer and a delivery driver, in order to coordinate arrival times as best as possible and accommodate for unexpected travel delays.

Once the order has been confirmed 301 (the restaurant can accommodate the order and the customer accepts the planned delivery time), the process begins tracking the customer's progress 303. Depending on the type of food ordered, it may be desirable to wait for a time before beginning food preparation. A restaurant may elect to prepare a sandwich immediately, but hot food may be prepared so that it is ready proximate to the planned delivery departure.

While the customer is traveling, the customer may encounter unexpected delays. The navigation system may not accommodate for a route delay or construction, or new weather or traffic can unexpectedly delay travel. The customer may also need to stop for fuel or other reasons, and all of this can amount to a new expected arrival time. Since the navigation process can estimate an arrival based on observed developing changes, if a delay in arrival at the destination is greater than a threshold tolerance 305 (e.g., 5-10 minutes), the process can send an update to the restaurant or to a order/driver-management system which can better coordinated food processing and/or driver departure based on the updated customer arrival time.

If there is no delay, then at some point in the customer's travel the process will receive a notification that the driver is leaving for delivery (or plans imminent departure) 307. If the customer plans a delay, or otherwise does not want the driver to leave yet, the customer may instruct the driver to wait or deliver a different order 309. This may result in a significant delay to the customer, but if the customer wants to stop at a store or to get fuel, the delay may be necessary. The driver can either choose to wait for the new delivery time or deliver another order, as appropriate. The customer's order can then be delivered by a later-available driver or added to another order for delivery later, as appropriate. Or the current delivery driver can deliver a second order first, and then circle back to the customer for the later delivery.

Once the customer has confirmed driver departure, the process receives information for tracking the driver 313. While driver tracking is not necessary, if available it provides for the ability to dynamically coordinate arrival times and to update both parties as they respectively progress and to accommodate for any delays experienced by either. The tracking can be an IP address for direct communication with a driver vehicle, or the driver vehicle can report position and/or delay information to a central server for handling. In some instances, restaurants may handle their driver location and an automotive OEM may handle the customer location and a central process may coordinate the information.

The process establishes some form of connection for tracking the driver 315, depending on the system employed. Driver data is received by the process 317 (which may be running on the vehicle or at least is in communication with the vehicle), and the driver is displayed on a customer display 319. If the driver and customer are too far apart, the process can display the driver off-map, with indicia indicating the approximate driver location, or the process can display information about the driver's travel time. It is possible that if a driver route and a customer route converge at some point, the process could make accommodation for a “hand off” of the order. For example, the process could select a parking lot along the common route and confirm that both parties are ok with exchanging goods at the designated location. This could speed up delivery, and allow hungry parties in the vehicle to begin eating sooner.

While the process is tracking the driver, the process is also tracking the customer progress 321. If the process determines that the customer is going to be delayed more than a threshold period of time 323, the process may notify the driver 325, in case the driver has another order that can be delivered first. If there is no delay, the process (or a similar process) may display the ETA of the customer in the driver vehicle as well 327. In this manner, both vehicles display up to both ETAs, so that both parties involved can know when the other party is arriving. The process sends customer route data to the driver 329 as needed, to facilitate the information display on the driver's end.

By tracking both parties until the delivery is completed, or at least until one party reaches the destination, the process allows for adjustments to be made by either party to accommodate an unexpected delay of the other party. A customer can stop for fuel, if an order is delayed unexpectedly due to traffic, for example, and a driver can deliver another order, if the customer is unexpectedly delayed. All of this can be done with limited or no direct conversation between parties, which allows all parties to focus on the task of driving. This can also result in improvement on the distribution of high-demand times for delivery restaurants, encouraging earlier ordering and lowering a “spike” time when everyone arrives home and orders simultaneously. So, for example, a restaurant that was typically busy from 5:30-7:00, and overloaded from 5:30-6:15, might discover that this encourages ordering as early as 4:45 and reduces overload as orders come in and are processed on a more appropriate “as the customer will be home” basis. Now the restaurant can have a longer busy time window and handle more orders in the aggregate because there should be less delay associated with peak hours.

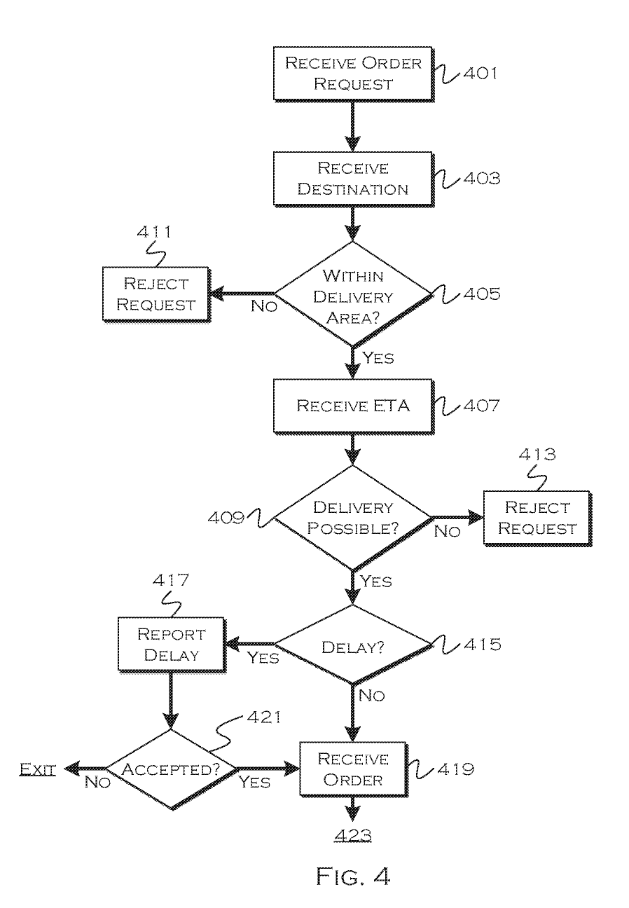

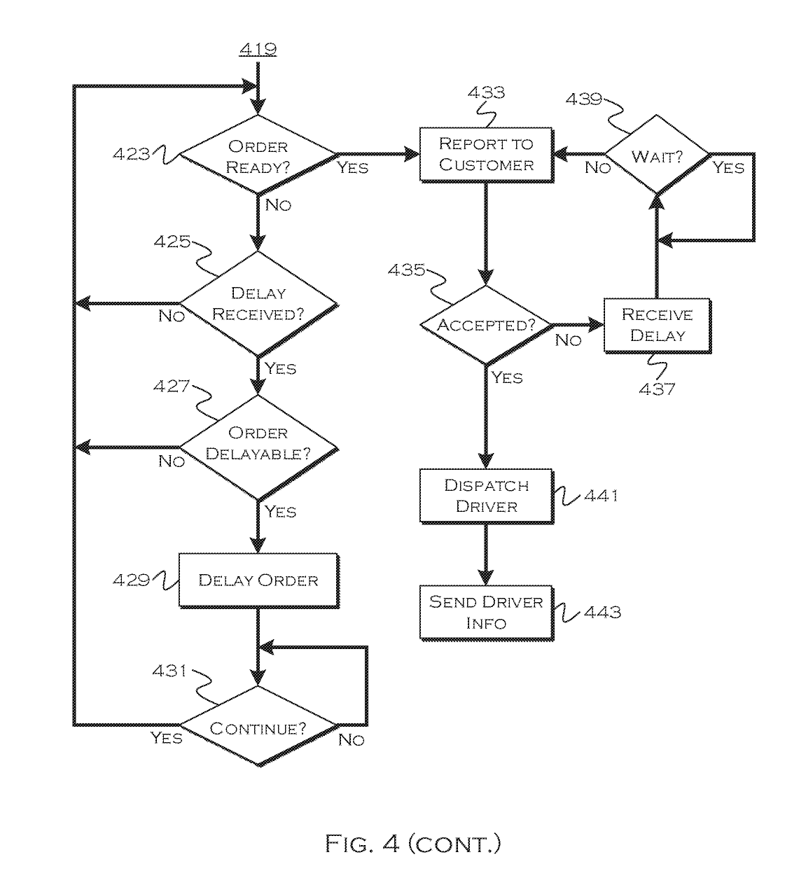

FIG. 4 shows an illustrative process for order handling. In this illustrative example, the process handles order processing and driver dispatch. In the hot-food industry, preparing an order when it is received is not always appropriate. Instead, it may be common practice, for example, to prepare an order thirty minutes before delivery is planned. Since it could be burdensome for a customer to have to place the order with such precise timing, it may be more reasonable to have a system to instruct when the order is processed, allowing the customer to order whenever they desire. Also, with a high volume of orders, it may not make sense to process the orders on a first in first out basis, it may make more sense to arrange the order handling according to when the orders will be delivered.

While many delivery restaurants may have some internal process in place to organize orders in the suggested manner, as suits their particular type of food, the illustrative embodiments provide for an improvement to this process in that they allow for dynamic accommodation of unexpected customer delay.

In this example, the process receives an order request 401 and a desired delivery destination 403. The process first determines if the delivery destination is appropriate and available 405 for the particular restaurant.

If the destination is simply not within a delivery area 405, the process can reject the order request 411. If the destination is acceptable, the process receives a customer ETA associated with the destination 407, to determine when the customer wants the food delivered. If the process determines that delivery is not possible at the requested time 409 (based on order processing time, driver availability and/or current order volume, for example), the process can again reject the request 413.

If the order can be completed and/or a driver should be available for delivering the order, the process then determines if a delay may be associated with the delivery. For example, if a customer requests delivery at 5:45 PM, and the process determines that delivery is likely available at 5:55 PM, there would be a 10 minute delay. The process reports this delay to the customer 417 and if the customer accepts the delay 421, the process can accept the order 419. In some cases, customers may elect to automatically accept some delays of predetermined time periods or less. Calculations about the availability of order delivery may include, for example, destination location, driver availability, current order volume, preparation time, and even order size. Other variables can also be accommodated, to maximize whatever metrics (customer base, order volume, revenue, etc) the restaurant desires.

Once the order has been received and confirmed, the process will determine if an order is ready 423 so that a driver may be dispatched when appropriate. While the order is still pending, the process may check to see if any unexpected delays have been received from the customer 425. If the customer reports an unexpected delay, the process determines if the order may be delayed 427. If the order may not be delayed, order processing will continue. If the order may be delayed, the process may instruct delay of the order 429, and wait until an appropriate time 431 to continue the order. An initial order processing start time may be set when the order is placed, for example, and then can be adjusted as needed based on reported delays.

Some examples of the preceding are as follows: A customer is traveling to a destination and orders food from restaurants A and B. Restaurant A serves pizza and restaurant B serves cold sandwiches. Both restaurants are running at capacity, so they would prefer to delay any orders as needed, in order to process first-deliverable orders first.

The customer provides an ETA of 1 hour. Restaurant A will begin preparing the pizza when 20 minutes have passed, to provide 40 minutes for preparation and delivery. Restaurant B may begin preparing the sandwich when 40 minutes has passed, to provide 20 minutes for preparation and delivery.

If a delay comes within the first 20 minutes, both restaurants can delay preparation for the duration of the delay. If the delay comes within the first 25 minutes, restaurant A may be able to still delay the order preparation, because the pizza may not yet be in the oven. Restaurant B can adjust the sandwich preparation start time accordingly. If the delay is reported 35 minutes after the order is placed, restaurant A may no longer be able to delay the order processing, because the pizza will be cooking. Restaurant B, on the other hand, may be able to delay completion of making the sandwich all the way up until the sandwich is wrapped and bagged. This allows restaurant B to accommodate for delays until the order is out for delivery, so restaurant B can handle more pressing orders first if a customer is unexpectedly delayed.

Once the order is ready for delivery 423, the process can report to the customer that the order is ready to go 433. If the order was well coordinated, this should occur around the time where the driver and customer have approximately similar arrival times at the destination. If the restaurant completed the order early, the process may wait until the correspondence between arrival times is near.

If the customer accepts the order delivery request 435, the process can dispatch the driver 441 and coordinate tracking through sharing of driver information 443. If the customer intends a delay for some reason, the customer may report an intended delay 437 and the process may wait the requested period of time 439 before asking again if the order should be delivered.

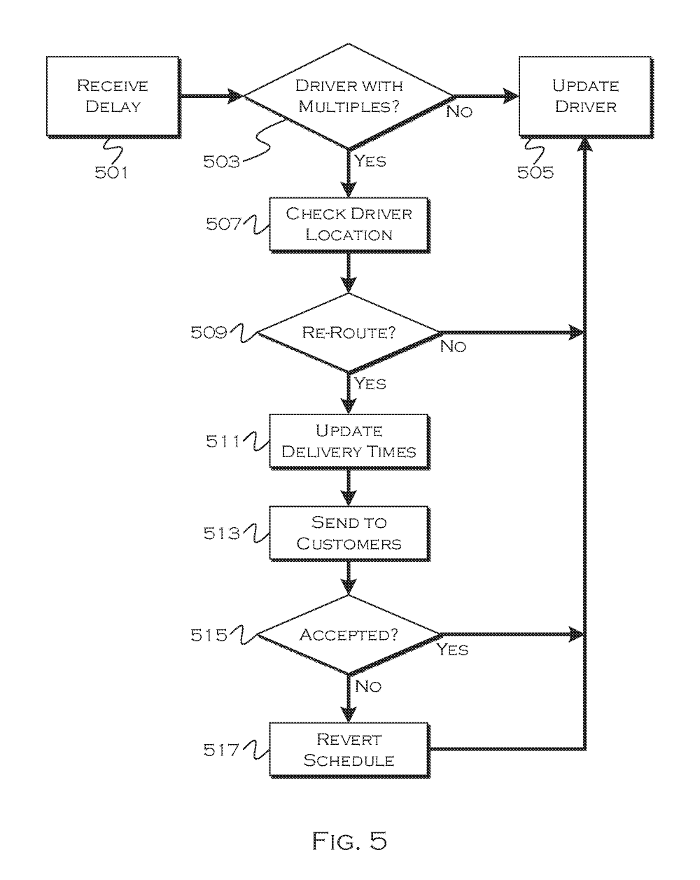

FIG. 5 shows an illustrative process for delay accommodation. In this illustrative example, the process reorganizes a driver's delivery schedule to accommodate for a delay. This is most useful in scenarios where a driver has multiple delivery orders in a close locale, although a variation on this process could be used to plan order delivery before driver departure to accommodate for delay, even if each driver were only taking a single order.

In this example, the driver is already on the road, and the process receives indication that a customer is delayed 501. If the driver has multiple orders 503, the process continues with re-routing. If the driver only has a single order 503, the process updates the driver 505 with information about the delay. If the delay is significant, the driver may want to return and deliver a new order while waiting for the delay to elapse.

If the driver has multiple orders in progress, the process checks a current driver location 507 and determines if a re-route is appropriate. For example, the process could determine how long it would take to deliver a second order first, and then to return to the original first destination to deliver the delayed order. If this re-route is similar or within a threshold of the delay time, this could be a good reason to re-route the driver. Or, if the driver has hot food, and if the driver waits for the delay period to deliver the second order, both orders may be cold upon delivery. In this case, the process may recommend re-route in order to ensure that at least one food order is delivered hot. Any re-route may also be subject to the availability of the customer-if both orders were placed using the illustrative embodiments, for example, it may be that the second customer will not be ready to receive the order until later in time, regardless.

If re-route is appropriate, the process will update expected delivery times 511 and send these new expected delivery times to customers as appropriate 513. It may be the case that the second customer has to accept the new, earlier time, before the process can continue, and the process may also give the original delayed customer the option to accept a later time, although this option can also be foregone if the delay is significant (i.e., the customer simply must accept the delay).

If the relevant customers accept the new schedule 515, the process updates the driver with a new delivery ordering 505, otherwise the process reverts to the old, original ordering 517.

Through the use of the illustrative embodiments and the like, delivery ordering can be expanded and timed with much greater accuracy. Accommodations can be made for customer and driver delays, and both restaurants and customers can realize an improved ordering and delivery process.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
receive a request for a food delivery order to be delivered to a current vehicle destination;
present food delivery options corresponding to the destination;
receive a delivery option selection;
facilitate a food order; and
instruct delivery initiation of the food order when a customer vehicle is within a first determined travel time of the destination, such that a delivery driver and the vehicle are estimated to arrive within a predetermined time of each other.

2. The system of claim 1, wherein the processor is configured to facilitate the food order by presenting a list of orderable options on a vehicle-related display, and receive selection of food from the presented list.

3. The system of claim 2, wherein the vehicle-related display includes an in-vehicle display.

4. The system of claim 2, wherein the vehicle-related display includes a mobile device display, the mobile device in wireless communication with the vehicle.

5. The system of claim 1, wherein the processor is configured to determine an amount of time projected for delivery of the food order, and to instruct delivery initiation when the vehicle is within a travel-time from the destination less than the determined amount of time.

6. The system of claim 1, wherein the processor is further configured to determine a processing time for the food order and to instruct preparation of the food order when the vehicle is within a second determined travel time such that the determined delivery time plus the determined processing time are within a predetermined threshold of the determined second travel time.

7. The system of claim 1, wherein the processor is configured to facilitate the food order by placing a phone call to the selected delivery option.

8. The system of claim 1, wherein the food delivery options corresponding to the destination include restaurants within a predetermined distance of the destination.

9. The system of claim 1, wherein the food delivery options corresponding to the destination include restaurants known to deliver to the destination, based on known restaurant delivery areas accessible from a database of delivery information.

10. The system of claim 1, wherein the food delivery options corresponding to the destination include restaurants having been pre-designated as delivery restaurants.

11. A system comprising:
a processor configured to:
receive a driver-departure notification when a delivery driver leaves to deliver an order;
receive driver-tracking information tracking delivery driver progress; and
display driver-arrival information, based on the driver-tracking information, on a customer vehicle-related display, indicating delivery driver estimated arrival time.

12. The system of claim 11, wherein the processor is further configured to display a representation of the delivery driver on the vehicle-related display, based on a delivery driver location on a displayed map and obtained from the driver-tracking information.

13. The system of claim 11, wherein the processor is further configured to display an indicator on a displayed map, indicating an approximate off-map location of the delivery driver.

14. The system of claim 11, wherein the processor is configured to determine a convergence between a customer route and a delivery driver route and offer a meeting location on a converged portion of both routes.

15. The system of claim 14, wherein the processor is configured to receive delay information relating to an unexpected delay in the delivery driver route and to display an indicator of the delay on the vehicle-related display.

16. The system of claim 11, wherein the vehicle-related display includes a vehicle display.

17. The system of claim 11, wherein the vehicle-related display includes a mobile device comprising a display, the mobile device being in wireless communication with the vehicle.

18. A system comprising:
a processor configured to:
receive indicia of a first-customer delay in a first destination arrival time;
determine if a delivery driver should deliver a second-customer order first, based on the first-customer delay;
confirm availability with a second customer to receive a second-customer order earlier than scheduled; and
responsive to confirmation, instruct the delivery driver to deliver the second-customer order before a first-customer order.

19. The system of claim 18, wherein the processor is configured to determine that the delivery driver should deliver the second-customer order first if the delivery driver will reach the first destination in a time period within a predetermined threshold of the first-customer delay after delivering the second-customer order before the first-customer order.

20. The system of claim 18, wherein the processor is configured to determine that the delivery driver should deliver the second-customer order before the first-customer order if the first-customer delay is greater than a predetermined time period defining an acceptable delay for delivering the second-customer order.
